(19) United States
(12) Patent Application Publication
(10) Pub. No.: US 2011/0134196 A1
(43) Pub. Date: Jun. 9, 2011

(54) Inkjet head

(75) Inventors: Jae Hun Kim, Seoul (KR); Yun Sung Kang, Suwon (KR); Min Young You, Suwon (KR); Ju Hwan Yang, Suwon (KR)

(73) Assignee: SAMSUNG ELECTRO-MECHANICS CO., LTD., Suwon (KR)

(21) Appl. No.: 12/805,451

(22) Filed: Jul. 30, 2010

(30) Foreign Application Priority Data
Dec. 4, 2009 (KR) 10-2009-0119609

(51) Int. Cl. B41J 2/045

(52) U.S. Cl. 347/71

(57) ABSTRACT

There is provided an inkjet head including: a flow path plate having a plurality of ink chambers; a nozzle plate having a plurality of nozzles connected to the respective ink chambers in order to eject ink in the ink chambers to the outside; a piezoelectric actuator provided above the ink chambers and controlling pressure of the ink chambers; and a parylene protective film provided in order to prevent oxidization of the piezoelectric actuator.

### CROSS-REFERENCE TO RELATED APPLICATIONS

This application claims the priority of Korean Patent Application No. 10-2009-0119609 filed on Dec. 4, 2009, in the Korean Intellectual Property Office, the disclosure of which is incorporated herein by reference.

### BACKGROUND OF THE INVENTION

1. Field of the Invention

The present invention relates to an inkjet head, and more particularly, to an inkjet head including a parylene protective film which prevents an upper electrode of a piezoelectric actuator from being oxidized.

2. Description of the Related Art

An inkjet head generally converts electrical signals into physical impulses so that ink droplets are ejected through small nozzles.

In recent years, a piezoelectric inkjet head has been used in industrial inkjet printers. For example, the piezoelectric inkjet head is used to directly form a circuit pattern by spraying ink prepared by melting metals such as gold and silver onto a printed circuit board (PCB). The piezoelectric inkjet head is also used for creating industrial graphics, or for the manufacturing of a liquid crystal display (LCD), an organic light emitting diode (OLED), a solar cell and the like.

In general, an inkjet head of an inkjet printer includes an inlet and an outlet through which ink is introduced and ejected in a cartridge, a manifold storing the ink being introduced, and a chamber transferring the driving force of an actuator so as to move the ink stored in the manifold toward a nozzle. In order to eject the ink in the chamber to the outside, a piezoelectric actuator formed of piezoelectric materials is mounted on the surface of the inkjet head.

The piezoelectric actuator includes a lower electrode, a piezoelectric layer, and an upper electrode that are sequentially stacked on a flow path plate. The upper electrode usually employs gold (Au), silver (Ag), copper (Cu), or the like.

Such materials forming the upper electrode are oxidized by most of the chemicals such as acid, alkali, or a solvent, thereby causing a problem of deteriorating the characteristics of the inkjet head.

Therefore, there is a need for a method of preventing the upper electrode of the piezoelectric actuator from being oxidized.

### SUMMARY OF THE INVENTION

An aspect of the present invention provides an inkjet head capable of preventing the oxidization of an upper electrode of a piezoelectric actuator using a parylene protective film as well as preventing a short circuit that may occur during driving.

According to an aspect of the present invention, there is provided an inkjet head including: a flow path plate having a plurality of ink chambers; a nozzle plate having a plurality of nozzles connected to the respective ink chambers in order to eject ink in the ink chambers to the outside; a piezoelectric actuator provided above the ink chambers and controlling pressure of the ink chambers; and a parylene protective film provided in order to prevent oxidization of the piezoelectric actuator.

The parylene protective film may be provided on inner walls of the ink chambers and the nozzles.

The parylene protective film may be provided on outer walls of the flow path plate and the nozzle plate.

The parylene protective film may be any one of parylene N(Di-Para-Xylylene), parylene C(Di-Chloro-Xylylene), parylene D(Tetra-Chloro-Xylylene) and parylene F(Octafluoro-[2,2] para-Cyclophane).

The parylene protective film may be a mixture of at least two of parylene N(Di-Para-Xylylene), parylene C(Di-Chloro-Xylylene), parylene D(Tetra-Chloro-Xylylene) and parylene F(Octafluoro-[2,2]para-Cyclophane).

The inkjet head may further include an intermediate plate disposed between the flow path plate and the nozzle plate, and having dampers connecting the ink chambers and the nozzles and at least one manifold connected to the ink chambers.

The parylene protective film may be provided on inner walls of the ink chambers, the nozzles, the dampers and the manifold.

The parylene protective film may be provided on outer walls of the flow path plate, the intermediate plate, and the nozzle plate.

The parylene protective film may be anyone of parylene N(Di-Para-Xylylene), parylene C(Di-Chloro-Xylylene), parylene D(Tetra-Chloro-Xylylene) and parylene F(Octafluoro-[2,2]para-Cyclophane).

The parylene protective film may be a mixture of at least two of parylene N(Di-Para-Xylylene), parylene C(Di-Chloro-Xylylene), parylene D(Tetra-Chloro-Xylylene) and parylene F(Octafluoro-[2,2]para-Cyclophane).

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cutaway perspective view illustrating an inkjet head according to an exemplary embodiment of the present invention;

FIG. 2 is a schematic cross-sectional view illustrating an inkjet head according to an exemplary embodiment of the present invention;

FIG. 3 is a schematic cross-sectional view illustrating a piezoelectric actuator in the inkjet head of FIG. 2; and

FIG. 4 is a schematic cross-sectional view illustrating the operation of an inkjet head according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Throughout the drawings, the same reference numerals will be used to refer to the same or like parts.

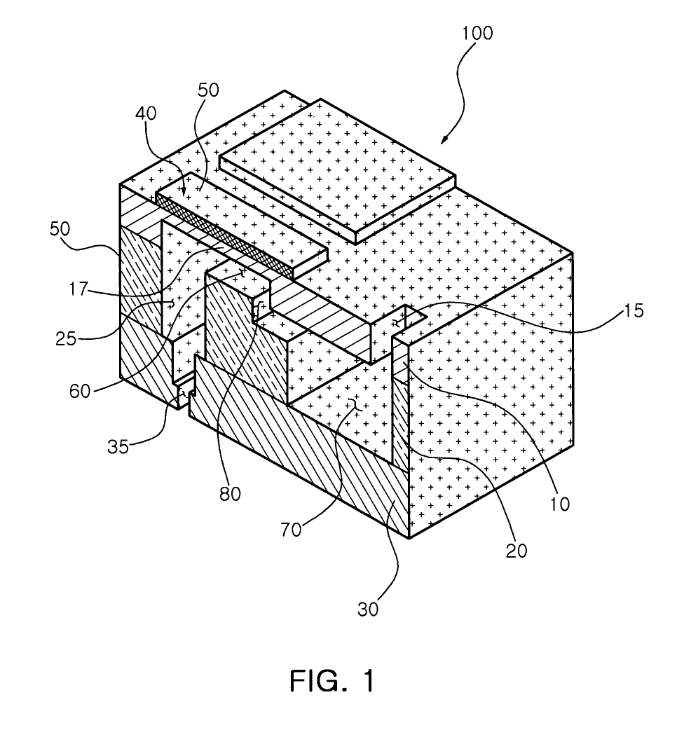

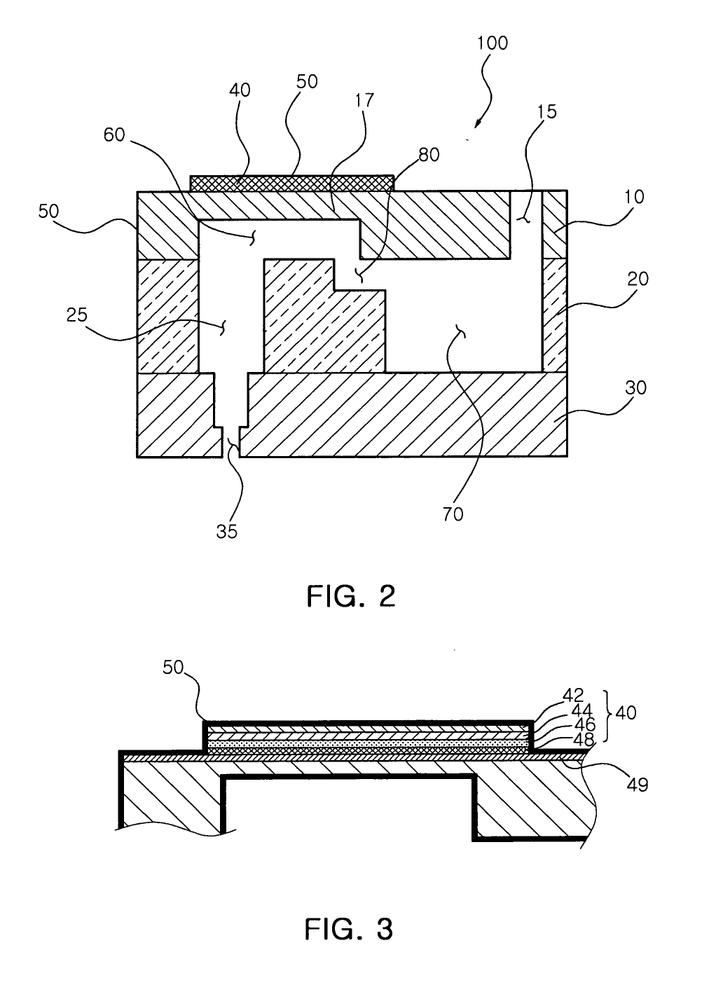

FIG. 1 is a schematic cutaway perspective view illustrating an inkjet head according to an exemplary embodiment of the present invention. FIG. 2 is a schematic cross-sectional view illustrating an inkjet head according to an exemplary embodiment of the present invention. FIG. 3 is a schematic cross-sectional view illustrating a piezoelectric actuator in the inkjet head of FIG. 2.

Referring to FIGS. 1 through 3, an inkjet head 100 according to this embodiment includes a flow path plate 10, an intermediate plate 20, a nozzle plate 30, a piezoelectric actuator 40, and a parylene protective film 50.

The flow path plate 10 includes a plurality of ink chambers 60 regularly formed therein, and an ink inlet 15 through which ink is drawn in. Here, the ink inlet 15 is directly connected to a manifold 70, and the manifold 70 supplies the ink to the ink chambers 60 through a restrictor 80.

Here, the manifold 70 may be a single large space to which the plurality of ink chambers 60 are connected. However, the invention is not limited thereto. A plurality of manifolds may be formed to correspond to the individual ink chambers.

Also, the manifold 70 may be prepared by forming a recess having an inner space in the intermediate plate 20 and the nozzle plate 30.

Similarly, only one ink inlet 15 may be formed to correspond to one manifold 70. However, when the plurality of manifolds 70 are formed, a plurality of ink inlets may be formed to correspond to the individual manifolds 70.

The ink chambers 60 are provided in the flow path plate 10 at positions located under the piezoelectric actuator 40. Here, a portion of the flow path plate 10 that forms the ceiling of the ink chambers 60 serves as a vibration plate 17.

Therefore, when a driving signal is applied to the piezoelectric actuator 40 in order to eject ink, the piezoelectric actuator 40 and the vibration plate 17 thereunder are deformed to reduce the volumes of the ink chambers 60.

Here, the reduction in the volumes of the ink chambers 60 increases the pressure inside the ink chambers 60, so that ink inside the ink chambers 60 is ejected to the outside through dampers 25 and nozzles 35.

The above spaces may be created in the flow path plate 10 by an etching process in order to form the ink chambers 60 and the ink inlet 15.

The intermediate plate 20 may include the manifold 70 having a large length extending in a longitudinal direction and the dampers 25 connecting the nozzles 35 and the ink chambers 60.

The manifold 70 is supplied with ink through the ink inlet 15 and supplies the ink to the ink chambers 60. The manifold 70 and the ink chambers 60 are connected with each other through the restrictor 80.

The dampers 25 receives the ink ejected from the ink chambers 60 through the piezoelectric actuator 40 and ejects the received ink to the outside through the nozzles 35.

The dampers 25 may have a multi-stage configuration by which the amount of ink ejected from the ink chambers 60 and the amount of ink ejected through the nozzles 35 can be controlled.

Here, the dampers 25 are optional. When the dampers 25 are removed, the inkjet head 100 only includes the flow path plate 10 and the nozzle plate 30.

The nozzle plate 30 corresponds to the ink chambers 60 and includes the nozzles 35 through which the ink passing through the dampers 25 is ejected to the outside. The nozzle plate 30 is bonded to the bottom of the intermediate plate 20.

The ink moving through a flow path formed inside the inkjet head 100 is sprayed as ink droplets through the nozzles 35.

Here, silicon substrates being widely used for semiconductor integrated circuits may be used as the flow path plate 10, the intermediate plate 20, and the nozzle plate 30. However, the flow path plate 10, the intermediate plate 20, and the nozzle plate 30 are not limited to silicon substrates, and may be formed of various materials.

The piezoelectric actuator 40 includes a lower electrode 46, a piezoelectric layer 44, and an upper electrode 42 sequentially stacked on the flow path plate 10 as shown in FIG. 3. The piezoelectric actuator 40 may be formed of Lead Zirconate Titanate (PZT) ceramics, which is one of piezoelectric materials.

As a method of bonding the lower electrode 46 to the flow path plate 10, a ground 49 is formed using gold (Au) on the surface of the flow path plate 10.

By applying an epoxy adhesive 48 to the ground 49, the lower electrode 46 is bonded to the flow path plate 10.

Here, the epoxy adhesive 48 may be in a liquid state without including a filler. By using the epoxy adhesive 48, the piezoelectric layer 44 and the ground 49 may obtain greater electroconductive characteristics.

The upper electrode 42 is formed on the piezoelectric layer 44, and the piezoelectric layer 44 is formed on the lower electrode 46 to be positioned above the ink chambers 60.

The upper electrode 42 serves as a driving electrode which applies the voltage of the piezoelectric layer 44. The upper electrode 42 is connected to a flexible printed circuit (not shown) for the application of constant pressure.

When driving pulses are applied by the upper electrode 42, the piezoelectric layer 44 and the vibration plate 17 are deformed to thereby change the volumes of the ink chambers 60. Accordingly, the ink inside the ink chambers 60 is ejected through the nozzles 35.

The parylene protective film 50 is a protective film formed of a parylene polymer. Parylene is a group of thermoplastic polymers formed in a vacuum state.

Unlike liquid coating, parylene coating permits easy, delicate control of coating thickness, as well as uniform coating thickness throughout the entirety of a product.

The parylene protective film 50 may be any one of parylene N(Di-Para-Xylylene), parylene C(Di-Chloro-Xylylene), parylene D(Tetra-Chloro-Xylylene) and parylene F(Octafluoro-[2,2]para-Cyclophane).

Also, the parylene protective film 50 may be a mixture of at least two of parylene N(Di-Para-Xylylene), parylene C(Di-Chloro-Xylylene), parylene D(Tetra-Chloro-Xylylene) and parylene F(Octafluoro-[2,2]para-Cyclophane).

The parylene protective film 50 is basically formed on the upper electrode 42 of the piezoelectric actuator 40. Besides, the parylene protective film 50 may be formed on the inner walls of the ink chambers 60, the manifold 70 and the nozzles 35.

In addition, the parylene protective film 50 may be formed on the outer walls of the flow path plate 10, the intermediate plate 20 and the nozzle plate 30.

The parylene protective film 50 formed on the upper electrode 42 may serve to prevent the effects of most of the chemicals such as acid, alkali, or a solvent, thereby preventing characteristics deterioration caused by the oxidization of the upper electrode 42. Also, the parylene protective film 50 insulates the upper electrode 42 from the outside, thereby preventing a short circuit that may occur during the driving of the inkjet head.

Further, the parylene protective film 50 formed on the inner walls of the ink chambers 60 and the manifold 70 forms a flow path surface of the inkjet head having hydrophobic property, thereby enhancing ejection efficiency as compared with a flow path surface having hydrophilic property.

The parylene protective film 50 formed on the inner walls of the nozzles 35 may prevent the wetting of nozzle surfaces during ink ejection.

As described above, the parylene protective film 50 may be formed on the upper electrode 42 of the piezoelectric actuator 40 and the inner walls of the ink chambers 60, the manifold 70 and the nozzles 35. However, the invention is not limited thereto.

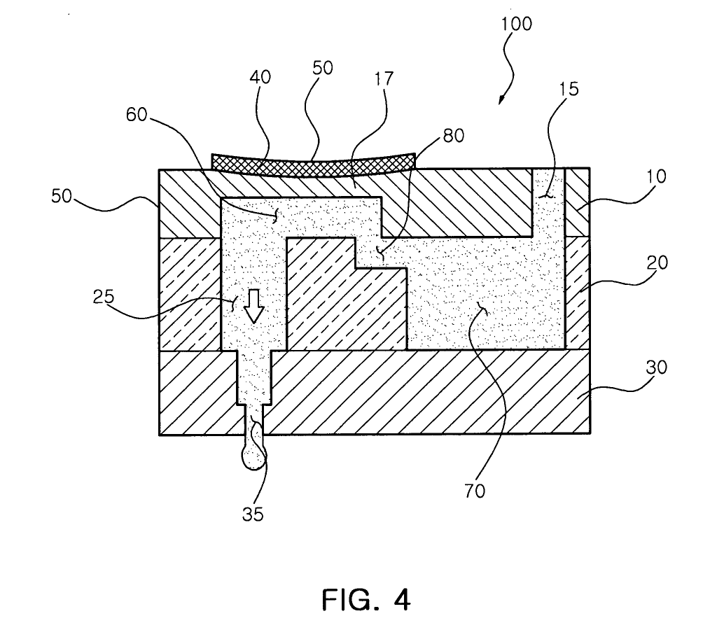

FIG. 4 is a schematic cross-sectional view illustrating the operation of an inkjet head according to an exemplary embodiment of the present invention.

Referring to FIG. 4, the piezoelectric actuator 40 is mounted on one surface of the flow path plate 10 close to the ink chambers 60.

When a driving signal is applied to the piezoelectric actuator 40 in order to eject ink, the piezoelectric actuator 40 and the vibration plate 17 thereunder are deformed to reduce the volumes of the ink chambers 60.

Therefore, when the piezoelectric actuator 40 vibrates downwards (in the direction of the arrow depicted in FIG. 4), ink inside the ink chambers 60 is ejected to the outside through the dampers 25 and the nozzles 35.

After the ink is ejected, ink stored in the manifold 70 is naturally moved to the ink chambers 60 through the restrictor 80 due to liquid pressure.

In this embodiment, the parylene protective film 50 is basically formed on the upper electrode 42 of the piezoelectric actuator 40, and is also formed on the inner walls of the ink chambers 60, the manifold 70 and the nozzles 35.

The parylene protective film 50 prevents the oxidization of the upper electrode 42 of the piezoelectric actuator 40 and prevents the wetting of the nozzle surfaces during the ink ejection. Also, the parylene protective film forms a flow path surface of the inkjet head having hydrophobic property, thereby enhancing ejection efficiency as compared with a flow path surface having hydrophilic property.

As set forth above, according to exemplary embodiments of the invention, the inkjet head has the parylene protective film formed on the upper electrode of the piezoelectric actuator and the inner walls of the ink chambers and the manifold, thereby preventing the characteristics deterioration caused by the oxidization of the upper electrode and enhancing ejection efficiency.

While the present invention has been shown and described in connection with the exemplary embodiments, it will be apparent to those skilled in the art that modifications and variations can be made without departing from the spirit and scope of the invention as defined by the appended claims.

What is claimed is:

1. An inkjet head comprising:
a flow path plate having a plurality of ink chambers;
a nozzle plate having a plurality of nozzles connected to the respective ink chambers in order to eject ink in the ink chambers to the outside;
a piezoelectric actuator provided above the ink chambers and controlling pressure of the ink chambers; and
a parylene protective film provided in order to prevent oxidization of the piezoelectric actuator.

2. The inkjet head of claim 1, wherein the parylene protective film is provided on inner walls of the ink chambers and the nozzles.

3. The inkjet head of claim 2, wherein the parylene protective film is provided on outer walls of the flow path plate and the nozzle plate.

4. The inkjet head of claim 1, wherein the parylene protective film is any one of parylene N(Di-Para-Xylylene), parylene C(Di-Chloro-Xylylene), parylene D(Tetra-Chloro-Xylylene) and parylene F(Octafluoro-[2,2]para-Cyclophane).

5. The inkjet head of claim 1, wherein the parylene protective film is a mixture of at least two of parylene N(Di-Para-Xylylene), parylene C(Di-Chloro-Xylylene), parylene D(Tetra-Chloro-Xylylene) and parylene F(Octafluoro-[2,2]para-Cyclophane).

6. The inkjet head of claim 1, further comprising an intermediate plate disposed between the flow path plate and the nozzle plate, and having dampers connecting the ink chambers and the nozzles and at least one manifold connected to the ink chambers.

7. The inkjet head of claim 6, wherein the parylene protective film is provided on inner walls of the ink chambers, the nozzles, the dampers and the manifold.

8. The inkjet head of claim 7, wherein the parylene protective film is provided on outer walls of the flow path plate, the intermediate plate, and the nozzle plate.

9. The inkjet head of claim 6, wherein the parylene protective film is any one of parylene N(Di-Para-Xylylene), parylene C(Di-Chloro-Xylylene), parylene D(Tetra-Chloro-Xylylene) and parylene F(Octafluoro-[2,2]para-Cyclophane).

10. The inkjet head of claim 6, wherein the parylene protective film is a mixture of at least two of parylene N(Di-Para-Xylylene), parylene C(Di-Chloro-Xylylene), parylene D(Tetra-Chloro-Xylylene) and parylene F(Octafluoro-[2,2]para-Cyclophane).
